(19) United States
(12) Patent Application Publication
(10) Pub. No.: US 2018/0223546 A1
(43) Pub. Date: Aug. 9, 2018

(54) METHOD AND DEVICE FOR APPLYING AN INSULATION TO BUILDINGS

(71) Applicants: Maria Elisabeth Holzweber, Landskron (AT); Georg Wasserfaller, JR., Landskron (AT)

(72) Inventor: Georg Wasserfaller, Sr., Landskron (AT)

(21) Appl. No.: 15/749,094

(22) PCT Filed: Jul. 27, 2016
(86) PCT No.: PCT/EP2016/067934

§ 371 Date: Jan. 30, 2018

(30) Foreign Application Priority Data
Jul. 31, 2015 (DE) 102015112614.1

(51) Int. Cl. E04F 21/12; C04B 14/46; C04B 18/24; C04B 30/02; E04F 13/02; E04F 21/16

(52) U.S. Cl. CPC E04F 21/12; C04B 14/46; C04B 18/245; C04B 2111/00146; E04F 13/02; E04F 21/161; C04B 30/02

(57) ABSTRACT

A jointless surface covering can be applied to building parts by a method and a device (2). A flow of a surface covering material (37, 92) and of an adhesive (94, 95) is sprayed onto an underlying plane which is situated on the building part. The surface covering material forms an insulation for the building part. Granules (92) are used for the surface covering material. The granules are misted with adhesive (94) and, carried by air, they reach an area to be covered, wherein the granules immediately adhere as a result of the adhesive, which undergoes a chain reaction. By virtue of the device (2), granules are supplied from a granules reservoir (8) and adhesive is supplied from an adhesive reservoir (46) and brought together in an air space via a nozzle assembly (60) in order to form the surface covering. A combing device (16) serves for separating granular particles (92), which pass into a flow channel (28) via a chute (24). In the flow channel, the granular particles are taken up by an air flow (36) from a fan (30) and fed to the air space.

The present invention relates to a method in accordance with the preamble of claim 1, which allows an insulation to be applied across entire surfaces to a building, to its individual walls or to ceilings of a building without having to damage the structure, e.g. by drilling holes. Application of the insulation is carried out particularly beneficially by a device in accordance with the preamble of claim 17.

In other words, the present invention deals with a jointless surface covering achieved by applying a sprayed surface covering material, wherein an adhesive is added. The impinged material is then able to bond and harden. An (insulation application) machine suitable for this application method may comprise a granulate reservoir, a fan, a hose for the adhesive, and a pump for the adhesive.

### STATE OF THE ART

To insulate buildings, builders often use insulation panels or insulation mats, which, depending on the insulation material, are good for thermal insulation, fire protection or acoustic insulation. As homeowners are occasionally able to observe, insulation panels are prone to additionally settle after installation or, if they were not attached with adequate care, to sag across their surface area. The installation of insulation panels, e.g. on a contorted old building, is also very time consuming. It is quicker to apply a coating, such as a plaster or paint, to a façade or a wall of a building, for which numerous spraying techniques and spraying machines are well-known. These techniques and machines provide advantages respectively for one specific application, although they can normally only be used for the originally intended materials. If insulation materials are inserted into spraying machines, obstructions, for example, can occur. Techniques and machines for applying the selected materials are therefore frequently specifically matched.

Patent application WO 2006/024 882 A2 (publication date: Mar. 9, 2006) from International Cellulose Corporation et al. pursues an ideally appealing look of a coating to be applied to ceilings or walls. A material comprising of cellulose fibers is suggested as a wall covering. An adhesive mixture and optionally a dispersant or gelling agent are mentioned as additional ingredients. Mixtures of various fiber sizes sorted out through screen gaps are supposed to be good for smoothing. Equipment for blowing the cellulose is designated as technology that is already well-known as of the application date and is not further clarified in the document. The appealing look of the surfaces is supposed to be produced by a finishing tool, for which various embodiments are considered.

For improving interior spaces, patent application publication DE 196 54 466 A1 (publication date: Oct. 23, 1997) from applicant, J. Kschiwan, suggests applying a wall coating consisting of cell structures and of mineral structure elements for glitter effects, e.g. by means of a spraying technique. The preparation process for the application by means of spraying comprises a swelling of the material in water to achieve a viscosity sufficient for spraying.

The application of an insulation and/or fire protection compound is described in both patents AT 399 899 B (publication date: Dec. 15, 1994) and CA 2 108 541 C (publication date: Aug. 18, 1993) as well as in the parallel German utility model DE 92 03 877 Ul (publication date: Jul. 30, 1992) from proprietor, Burian Gesellschaft M.B.H. & CO. KG. With a machine mounted on rollers (see FIG. 1 of AT 399 899 B), it should be possible to use asbestos substitutes with similarly effective fire protection properties through a method for monolithic application on an area by means of a spray gun. Here, first the insulation and/or fire protection material and then a powdery hardener should be introduced into a volume of air and mixed and fed by means of air. A binder or adhesive should also be used. For the utilized machine, a feeder fan should be connected with its suction side to one end of a feed channel for the insulation and/or fire protection material and the powdery hardener. This configuration seems as though it would create unfavorable flow conditions.

The topic of spray insulation is also discussed in patent specifications of Wollner-Werke, e.g. in DE 27 34 839 C2 (publication date: Feb. 8, 1979). Primary emphasis of the statements in the publications is dedicated to an adhesive for the spray insulation using mineral fibers, which should be used as an alternative to asbestos insulation. A metallic substrate serves as the carrier material because the developers of the presented adhesive, which must be resistant to at least 1000° C., primarily had power plant turbines in mind as the field of application. Using the adhesive, fibers are intended to be sprayed onto a surface to be insulated in one process. This makes the layers so thick that metal is supposed to be protected even against corrosion.

Patent application DE 31 18 601 A1 (publication date: Nov. 25, 1982) from Grunzweig+Hartmann and Glasfaser AG assumes the technology of spray insulating by means of mineral fibers and a binder or hardener to be additionally conveyed, the mixing of which occurs only behind the outlet opening. The publication describes a device for spray insulating in the form of a nozzle head. Binders and hardeners are fed to an area in front of the nozzle head by means of a gaseous carrier medium, such as air. Nozzle obstructions of the multi-component nozzle configuration can occur here, which cause an uneven discharge, through which an adhesion of the fibers to each other or to a wall is compromised, and necessitate extensive cleaning work. Similar problems can occur both with the binder as well as with the hardener, which is why separate outlet openings are used for binders and hardeners before these agents reach the carrier medium, i.e. air. The recommended configuration is designed in such a way that the outlet openings for binders or hardeners are present as forward center openings, which are encompassed by a ring opening for the carrier medium, i.e. air. As a result, an adhesive should only form if the components of air, hardener, and binder come into contact with each other. If ring openings are partially closed due to the fibers applied during work, then hardeners and binders can no longer be evenly applied. The document does not explain how the mineral fibers are to be fed or applied. Various ring channels must be provisioned in the nozzle head for the supply line, which on the one hand are relatively expensive to manufacture, and on the other hand may clog. Disassembly of the nozzle head in the construction site environment will surely encounter difficulties.

Another option for coating objects only with a sprayed material is described in patent application EP 192 097 A2 (publication date: Jan. 31, 1986) from Kopperschmidt-Mueller GmbH & Co KG. With the help of an atomization device, a spray jet should develop, with which pneumatically atomized material and hydrostatically atomized material can be applied in a hollow jet/core jet configuration. With simultaneous atomization, a new spectrum of particles should emerge. Another application option is seen in the application of two-component lacquers. The possibility of electrostatically charging the particles is mentioned in order to distribute more particles on the object to be coated.

Examples for compositions of polymer powder compositions that are redispersible in water, which are considered, e.g. for the production of construction adhesives or as binders for coating agents, originate from DE 197 33 166 A1 (publication date: Feb. 4, 1999) from Wacker-Chemie GmbH.

Patent application EP 0 023 352 A1 (publication date: Apr. 2, 1981; priority application: DE 29 30 748 A1) from applicant, Josef Frager, relates to a spray gun. The description starts with the known plaster or concrete application machines, which are intended to utilize a concrete spraying technique. It is explained why the widely known machines for applying plasters and concrete are not suitable for processing thermal insulation coatings, particularly when using fiberglass. The materials to be applied should have thermal and/or acoustic insulating properties. The spray gun depicted in FIG. 1 of EP 0 023 352 A1 is specifically designed for processing insulation materials on a polystyrene base. Thermal insulating coatings should be formed with the addition of a binder through the blown synthetic material, also referred to as filler. An additional jet spraying process of fiber material is likewise mentioned; although its feed process is not explained in further detail. The filler is fed to an outlet opening by means of a pressure necessary for this. There is reason to fear that this compromises the pressurized filler, whereby the dispersion upon applying it diminishes as do the insulating properties. The spray gun should be beneficial for squeezing binder out through nozzles. They warned against binders foaming due to aeration, which is detrimental for the adhesion of filler granules. With respect to flammable rigid polystyrene foams, homeowners repeatedly raise questions as to whether or not they can achieve sufficient fire protection on a building and if fumes caused by a fire pose an additional health risk.

A system for rendering or applying a finish or a coating onto a surface, e.g. of a metallurgic container, is described in DE 43 34 231 A1 (publication date: Apr. 20, 1995) from Daussan et Compagnie. The coating should be, e.g. insulating or fireproof. The application of double layers of a differing composition is also considered. Below a silo of the system, in which a scraper turns to dissipate a finely powdered mixture, there is a chamber, in which a likewise motorized rotary valve is arranged. The utilized mixture, which is mixed with water, passes from this chamber into a tubular body and is fed by a pump to a spray nozzle. The rotary valve rotates about a vertical axis and causes the mixture to dispense by operating openings in a fixed disk. An Archimedean screw is arranged in the tube body for conveying the mixture. A screw pump is recommended as a pump. It should be assumed that the mixture is highly mechanically stressed during circulation before it discharges through a spray nozzle for application.

A mineral fiber spray and blow-in method with a foam support system is described in application DE 41 33 541 A1 (publication date: May 7, 1992) from F. Willich Dämmstoffe and Zubehör GmbH & Co. Special foam is added to an insulation and soundproofing material in a mixing hose shortly before exiting a blow-in hose and the mixture is then collectively discharged through a spray nozzle. Here, the finest fiber particles should be discharged suspended in a foam cushion. The support foam should disperse during the drying process, such that a solid molded part emerges consisting of bonded fibers. Although a dust-free introduction of the mineral fibers is spoken of, we might assume nowadays that the provisioning and feeding of the insulation material in the form of individual fibers in a process sequence give rise to health concerns.

Pursuant to patent specification DE 37 86 630 T2 (publication date: Apr. 6, 1988) from proprietor, Isover Saint-Gobain, in situ manufacturing consisting of a composition containing fibers or particles should be undertaken for a thermal insulating product. Glass or rock fibers coated with a so-called reactive polyvinyl alcohol polymer can be used, wherein the polymer should be suitable for manufacturing an insulating wool mat in the presence of a suitable cross-linking agent and with the addition of water. For example, a mixture is processed, for which a fibrous felt material was first shredded, coated with a polymer, and dried. A powdery coagulant is then added to the flakes or basic tufts of the fibers formed in this manner. It should also be possible to spray the fibers together with a water-based or dispersed coagulant onto a substrate in order to form an insulation layer. Borate or aluminum sulfate could be considered as a coagulant. Due to the fact that all fibers must first be prepared, e.g. through polymer coating, the processes in accordance with DE 37 86 630 T2 seem to be relatively complex. The device intended for spraying functions with a compression chamber for fiber flakes, in which the blades move. The compressed fibers are captured by the teeth of a carding unity and torn or shredded into fibrous particles. The material is then further conveyed in a rotor/stator configuration, wherein the rotor has cells in the cylindrical stator, which are formed by restricting blades with sealing tabs. Here, the rotor should have the function of moving the particles into an air flow on the base of the stator, which then carries the particles respectively from a cell so as to manufacture the insulation mat from that on a conveyor belt. The mats are then fed to a kiln. In this regard, this seems to be, as possible, a fully automatically functioning production system for insulation mats. The methods presented in DE 37 86 630 T2 produce insulation mats, for which the known butt joints are necessarily formed.

### Object

Insulation materials, which are applied to buildings, should enhance the living atmosphere in the buildings—ideally in consideration of the environment of the buildings. Workers, who, in particular, install building insulation on a regular basis as well as homeowners desire a process, with which insulation can be applied easily, quickly, and effectively as possible. It would be conducive if the ecological compatibility of the utilized materials can be obeyed. In other words, it is desirable to have a method and a machine for applying insulation materials, which function in the most resource-friendly manner possible. A machine that is gladly used by workers should be designed so simply that it can be safely operated without extensive technical training and used on various buildings in order to apply insulation, e.g. onto a wall.

### Description of the Invention

The object of the invention is achieved through a method according to claim 1; a suitable device that serves to achieve this object is provided in claim 17. Beneficial embodiments can be found in the Dependent Claims.

Contrary to the widely established method of insulating buildings and building parts with panel-type or rolled insulation elements, the method according to the invention offers options for avoiding joints and butted edges. Even butt joints or cracked walls that are already present on the building surface can be covered, filled in or sealed. This method allows surfaces on building parts or entire buildings to be fully covered, wherein only translucent areas, such as windows and doors, or movable areas, such as bearings or hinges, are excluded. The surfaces must only be minimally pretreated, if at all, e.g. by removing loose parts or potentially removing dust or grease. It is possible to forego a pretreatment involving the application of an adhesive primer or a sealer on the surface.

The method according to the invention is also applicable to buildings, particularly old buildings, or even on modern, architecturally visionary building structures that can have concave or convex surface elements, curves or polygonal areas, alcoves, and ledges. The method according to the invention can produce an insulation, particularly a thermal insulation, with special challenges due to the structure of the area to be insulated. The method according to the invention averts having to cut panels or mats and assemble them as well as the time-consuming installation that accompanies this process. From one aspect, insulation that is assembled from cut elements is always a small-scale insulation compared to size of a building, for which there are connecting areas, such as joints and butted edges. Thanks to the method according to the invention, joints and butted edges that reduce an overall effect of an insulation and are, e.g. unfavorable for the energy footprint of a house, can be avoided in many areas. The hazard of exposed joints, which are areas prone to erosion, is thus reduced. Joint erosion occurs gradually due to weather conditions or even due to living organisms settling.

For example, metal, wood, brick, clay, natural stone or concrete, particularly even aerated concrete materials are suitable as a substrate for the insulation layer to be applied, i.e. as a substrate material of the building or building part. Surfaces to be insulated are often warped or crooked or porous. The surface covering can serve to fill in or level undesired structures or wall damage, such that no preliminary work is required for smoothing. By means of a surface covering, the surface of a building part can be modeled into a desired shape. It is even possible to apply the surface covering to roofs or to ceilings from below. At least selected surface coverings are also suited for interior spaces. The covering can be applied to a building part with a pre-specified thickness. Compared to insulation techniques, for which insulation panels are adhered or screwed to a wall individually, the work effort could be reduced overall to a third.

The application onto the surface occurs without contact by spraying. Based on the spraying technique, a joint-free complete covering of a wall surface, such as the entire side wall of a building, can be achieved. Works for applying the surface covering are possible with a minimal amount of muscular strength. For example, between 1 m³ and 6 m³ (cubic meters) of a surface covering of a façade can easily be applied by one worker per hour (depending on the spraying speed), i.e. depending on how the device used for spraying is designed and set. The spraying process, which, from various perspectives, can also be referred to as spraying, rendering, coating or applying, occurs over a distance. Even difficult-to-access spaces, such as cable ducts, can be reached. Spraying implies among other things that it is beneficial if a spraying device is used for the application. The sprayed material forms a flow. A first part of the flow is a surface covering material. A second part of the flow is an adhesive. Additional parts can be provisioned. The material to be applied preferably contains liquid parts, which can have a gel-like viscosity, and particularly solid parts that have a stable volume. The adhesive is preferably flowable as a raw adhesive material, particularly even then if it comprises a gel. The flow may comprise particles, droplets, and a carrier medium, such as air. The flow can be directed to towards a building part. A direction of flow as well as an initial point of flow originating from a starting position at the onset of spraying can be changed as necessary, particularly manually, e.g. for establishing a specified covering thickness.

The surface of a building, onto which the flow is impinged, can also be referred to as an underlying plane. In one embodiment, a previously applied layer can be the surface, which has irregularities as an underlying plane. The surface covering material can be applied as a final coat, which is exposed to environmental impacts, such as weather conditions. It is also possible to cover the surface covering material as a finish with another coat, e.g. a mechanical protective coating, a paint coating, an adhesive coating or a layer of surface covering material. Complete pre-finished buildings parts can be manufactured in this manner. However, a building consisting of assembled pre-finished building parts can also be subsequently covered by spraying on surface covering materials and adhesives, and at least be soundproofed or insulated or protected as a result. It is also possible that an initially applied layer is a first layer of an insulation material, a soundproofing material or a protective coating, such as a wood protective layer. Common surface covering material layer thicknesses are, e.g. 15 cm (centimeters). Efficient soundproofing or insulation is achieved with a layer thickness of just 5 cm. Layer thicknesses of 50 cm and even more than 50 cm of thickness can be constructed. Depending on the desired design, the thickness of the surface covering can be greater than the wall thickness of the building to be covered. In conjunction with adhesive, the surface covering material is especially suited for insulating a surface of a so-called passive house in an energy-efficient manner. This allows for substantial heating cost savings.

The method is also beneficially applicable for filling in or sealing spaces or wall areas. These spaces are provided, for example, in a half-timbered construction, which depicts the building part. As a static structure, the surface covering material can harden in spaces as a support structure.

The sprayed flow adheres on the surface after being impinged. An impingement momentum of the flow should be sufficiently minimally adjustable, such that (substantial quantities of) surface covering material in conjunction with adhesive does not ricochet off the surface, particularly a surface coated with adhesive. The surface covering material reaches the underlying plane preferably together with the adhesive. The surface covering hardens supported on the underlying surface. Upon hardening, a respectively present bond solidifies between the surface, the surface covering material, and the adhesive. Hardening occurs in such a short period that run-off of the surface covering on a wall, particularly a wall surface, due to gravity is largely or entirely precluded. Prior to solidification, a run-off distance on a vertical wall is at least smaller than the covering thickness. In other words, a layer thickness of the covering represents a maximum limit for the run-off distance, which is preferably less than 1 cm.

Granulate can be used for forming the insulation material. Granulate is a solid that comprise a number of particles, which are also referred to as granular particles. It is beneficial if the granulate is pourable like a liquid as there is no rigid connection between a number of granular particles. One example for suitable granulate is rock wool granulate, which combines particularly beneficial properties, e.g. for fire protection, thermal protection, and noise protection. Granulate forms a part of the surface covering material.

Granulate, particularly a granulate particle, has a granulate particle surface, which features an air resistance. Kinetic energy can be transferred to the granulate, particularly granulate particles, through the flowing air. The granulate can be carried by an air flow to a surface to be covered. The granulate moves in a predetermined direction carried by air. The air flow provides for at least a partial compensation or overcoming of a gravity affecting the granulate.

The granulate is a raw insulating material. Raw insulating material is transported by air in a dry state. The raw insulating material can provide multiple insulating properties. At least one additional material must be combined with the raw insulating material so that an insulating material emerges from the raw insulating material. A raw insulating material can be processed into an insulating material, particularly at a construction site.

An additional material to be used is an adhesive. The adhesive facilitates an arrangement of the raw insulating material as an insulating material. The adhesive is applied as a mist. It is also possible to say that the adhesive, like a mist, is carried by air and envelops the raw insulating material. A mist has droplets that originate from at least one liquid. The granulate is applied in order to achieve a surface to be covered, wherein an area of misted air is crossed by the granulate. A direction of movement of the granulate is limited by the surface to be covered. The granulate contacts the surface to be covered. Adhesive contacts the granulate and the surface to be covered. This contact can also be referred to as an impact. Upon impact, at least one directional component of a granular particle motion stops. The adhesive prevents the raw insulating material from ricocheting from the surface to be covered. In other words, the granulate bonds to the surface to be covered by conveying the adhesive. Granulate particles are momentarily stopped on the surface to be covered, particularly on a building part or on applied granulate, due to the adhesive. The adhesive affects the granulate without a temporal delay upon spatial contact. A reaction of the adhesive occurs, particularly within less than one minute, preferably within less than 10 seconds. An initial reaction of the adhesive can already occur within a fraction of one second, e.g. less than a half second. The reaction of the adhesive causes—at least in the outcome—a concatenation of the granulate. From one aspect, particularly with respect to load carrying capacity, it can be said that a bridge between the granulate particles and a surface to be covered is formed by a concatenation. The concatenation can be extended, e.g. through the closing of chemical compounds, such as with a polymerization. In the case of a concatenation by means of the adhesive, a binding force increases between the parts to be concatenated within a few seconds. The surface covering material begins to harden. During hardening, the bridge formed by the adhesive becomes durable, particularly for a weight of at least a granulate particle. Granulate and adhesive, which begin to harden when combined, are already dimensionally rigid with respect to an effect of gravity prior to the complete hardening. Within a defined period of time, e.g. in a period of less than 5 minutes, the surface covering material can be converted into a modeled shape, for example by means of a tool, such as a trowel. After sufficient time has passed, the adhesive dries completely. An adhesive, particularly a first and a second adhesive, can also be advantageously used, which only hardens after 15 minutes or, particularly as a second applied adhesive, even after an hour if shaping, such as smoothing, is supposed to be done, e.g. after spraying.

A device for applying a jointless surface covering material is preferably designed in such a way that it is suited for implementing a method according to the invention.

The device enables work on building parts, particularly from scaffolding. The device comprises a granulate reservoir. A worker can fill a, preferably pre-measured amount of granulate into the granulate reservoir through a feeder or manually from portable granulate package sizes of, e.g. 30 kg. The granulate reservoir is connected to a fan, such as a radial fan, e.g. via a connection area, such as a tube, a hose or even a flange. The fan provides an air flow. The fan produces an air pressure, which is higher than an ambient air pressure. The fan serves to expedite granulate, wherein granulate is expedited, i.e. picked up, from the outlet-side air flow. To convey the granulate, it can be fed to a granulate fan hose from the granulate reservoir. A granulate fan hose is preferably designed such that an air flow is unobstructed to the extent possible. From another perspective, a granulate fan hose has a cross section, which is preferably at least four times larger than a maximum cross section of a granulate particle. This prevents blockages. The granulate fan hose can have support elements, such as a series of rings or a spiral or a woven fabric along the length of the hose, through which an undesired kinking of the hose is prevented. In other words, the hose preferably has a minimum bending radius, which is greater than a hose diameter.

The device comprises an adhesive pump. The adhesive pump is a conveyor system for adhesive, wherein the adhesive is preferably premixed and liquid. The adhesive pump is connected to an adhesive hose. The adhesive may be present, e.g. in an adhesive reservoir. The adhesive pump serves to supply the adhesive as uniformly as possible. The adhesive pump introduces the adhesive from the adhesive reservoir into the adhesive hose, preferably under an adjustable, constant pressure.

An additional component of the device is a nozzle assembly. The nozzle assembly serves for applying the granulate and the adhesive. The nozzle assembly can be fed with granulate, particularly as a raw insulating material, through the granulate fan hose. The nozzle assembly is arranged on the outlet side of the granulate fan hose. An inner wall of the nozzle assembly is preferably connected to an outer wall of the granulate fan hose or to an inner wall of the granulate fan hose, particularly continually, in order to achieve as low of a flow transfer resistance as possible for the granulate.

The granulate can leave the granulate reservoir, preferably by sliding out through the effect of gravity on the granulate or as the result of a conveyor unit. A combing device is connected to the granulate reservoir. The combing device is shaped so that granulate particles that land in the combing device can be separated. From one perspective, a first granulate particle is stripped from a second granulate particle during separation. From another perspective, a granulate particle is not compacted by the combing device. The combing device maintains one size of the granulate particles, wherein potential minimal wear is to be refrained from with this more global or general consideration, e.g. of individual fibers or individual surface areas. The combing device works to maintain granulate. The combing device is arranged between the granulate reservoir and a chute. It is also possible for the granulate to pass from the granulate reservoir to the combing device via a first chute. The chute, particularly a second chute, is allocated to a flow channel. At least one chute serves for introducing the granulate into the flow channel, which can also be referred to as a conveyor channel. The flow channel is connected to the fan. An air flow passes from the fan into the flow channel. The air flow absorbs the granulate particles and carries the granulate to the granulate fan hose. Air and granulate thus pass into the granulate fan hose on the input side. Air and granulate flow through the granulate fan hose to the nozzle assembly.

The nozzle assembly is designed for emitting granulate and adhesive. In other words, the nozzle assembly has at least two inputs, through which the granulate and the adhesive can be separately fed. After being emitted from the nozzle assembly, the adhesive passes into the same air flow that goes from the fan, preferably a radial fan, and that conveys the granulate. Adhesive and granulate pass at least over a partial distance carried by air to a building, wherein over the partial distance the nozzle assembly does not hold any lateral flow restriction, i.e. it is free of flow restrictions from a lateral perspective. A surface covering of granulate and adhesive accrues on the building by means of adhesion.

Additional benefits of the device emerge, for example, from the following designs achievable with individual embodiments, which may independently reveal innovative aspects. It is possible to deviate from the exemplary values to greater values or even to lesser values through advantageous designs according to the invention.

One embodiment of a respective device allows for the spraying of the surface covering, e.g. a working radius of approx. 300 m (meters) in a horizontal direction and approx. 15 m in a vertical direction. A nozzle assembly is preferably light enough, e.g. by means of a nozzle assembly weight of less than 1 kg (kilogram), that it is also possible to work overhead, particularly when spraying a ceiling. An output of the device, particularly of the granulate, should be advantageously infinitely adjustable, e.g. in a range of approx. 0.5 m³ (cubic meters)/hour up to 6 m³/hour. It is also possible to design the device in such a way that an output of 6 m³ is achieved in 15 minutes so that a maximum output of 24 m³/hour would be provided. The liquid adhesive is conveyed, e.g. with a pressure of 9 bar. A pneumatically-powered pump can be used for this, which provides, for example, an output of up to 23.4 liters per minute with an operational compressed air of up to 24 bar. The output of the adhesive can therefore be quickly adjusted to the respective need. The device can be designed in such a way that an electrical power consumption between 0.5 kW (kilowatt) and 6 kW, and preferably less than 10 kW, such that, e.g. off-grid operation is possible, such as with a diesel-powered generator integrated in the device.

Advantageous embodiments and additional configurations are presented below, which themselves may reveal likewise innovative aspects both individually as well as in a combination.

One potential material, which is suited as a source material for the flow of the surface covering material, is a granulate consisting of flakes. The flakes can be produced from fibers. Fibers can be matted, e.g. in flakes. Application e.g. spinning of the fibers occurs advantageously previously on a large-scale, e.g. via nozzles. Fibers can be centrifuged or drawn, wherein drawn fibers have a more controlled geometry and a greater vibration-resistance than centrifuged fibers. Flakes can be formed, e.g. in a pendulum process. Flakes can also be produced by shredding spun material. Considering ecological aspects, the use of cut mat material or cut roll material, which falls off in the form of mats or rolls during the production of insulation material, is particularly beneficial. The material is shredded into flakes. Shredding may occur, e.g. by shearing, ripping or tearing. Granulate are produced from flakes through additional shredding, such as grinding or mechanical grating. A hammer mill or kieserite machine can be used for shredding. The kieserite machine is a separating machine with a sloping cylindrical sieve, such that granulating is enabled inside the sieve through rotation. For one selected method for producing granulate, the flakes and the granulate should be compacted as little as possible. At least one surface area of the granulate can be wetted by an adhesive, wherein an overlapping area, such as an outer shell of a granulate particle, can be formed.

The fibers being part of the granulate, particularly mineral fibers, preferably have a fiber diameter greater than 3 μm (micrometers). A fiber diameter of an animal wool fiber is typically between 15 μm and 40 μm. From a medical perspective, bio-soluble fibers, which can be decomposed with a half-life of less than 40 days following absorption in the human body, are considered to be particularly beneficial. The carcinogenic index of the fibers considered to be a source material should exceed the number 40 if possible. A granular particle can be formed from a ball of fibers. Through the use of adhesive, at least a part of the fibers is enveloped by an adhesive matrix.

The granulate, particularly rock wool granulate, preferably has a grain size between 6 mm and 8 mm. From one perspective, the grain size can be understood as a synonym for the term particle size of the granulate. The granulate can be present in the form of balls with an average particle diameter of 6 mm to 8 mm. A homogenous spherical shape of granular particles enables a formation of an even surface. By using a preferably homogenous granulate particle size, only small spaces arise between the granulate particles. The spaces are preferably smaller than twice the particle diameter. The actually used size (in relation to the diameter) of granulate, such as an average diameter of 4 mm or an average diameter of 12 mm, has an impact on the density of the insulation layer to be produced. A first insulation layer can be applied, which has a larger particle diameter than a second insulation layer to be applied. The second insulation layer can in other words serve to form a particularly smooth finished surface or façade surface. The first layer in turn, can be designed for a rapid construction of a layer thickness.

The granulate can be stored, e.g. in sacks, for many years. However, the hazard cannot be precluded that the granulate consolidate slightly during storage, e.g. by less than 10% of the granulate volume. Individual granulate particles may adhere to each other through interlocking or bonding, wherein it has been shown that clumps of granulate particles potentially form during storage. To enable an even application of the granulate, it is beneficial if the granulate is mechanically pretreated. Particularly a combing device is well suited for pretreatment. The combing device is designed such that the granulate is not torn or cut. Tines of the combing device preferably apply shear forces on clumped granulate, so that the clumps disintegrate. At least potentially present clumps are broken up. The granulate particles can be detached from each other and sporadically applied as a surface coating. This results in a more even surface coating.

Granulate can be produced from wool. One option consists in obtaining flakes from rock wool, which can also a referred to as granulate in one form. The process is particularly well suited for the use of highly compatible, particularly mineral, raw materials. Flakes can be produced initially in an early process step, e.g. in one of the first steps of rock wool production in the form of rock wool panels or rock wool rolls. Shredded, mineral material, e.g. from a rock quarry, such as a mixture of diabase, particularly dolomite, spilite or picrite basalt and basalt, is used for production. Combinations of some or all of the minerals, spar, dolomite, basalt, diabase, and anorthosite can also be used as source materials. Rock wool can also be produced from recycled materials, at least as an additive. The utilized source materials are preferably mixed as mineral granulate, which consists of various parts of the aforementioned source materials. The granulates are often fused in a (vaulted) oven using coke or mineral oil and a fan blowing the burning mass in order to exceed the melting temperatures of the minerals. To produce the rock wool, the mineral melt is squeezed or drawn through nozzles. Cut mat material or cut roll material is especially good to use, which is previously fed back into the production process of rock wool for melting. Material is preferably used, which was not blended for additional processing, particularly for compaction, with phenol resin.

In one beneficial design, it is possible that the granulate have different wool parts. Usable types of wool are rock wools. Glass wool can likewise be used for producing granulate. Glass wool can be produced, e.g. ecologically efficiently from waste glass. Additional beneficial usable wools are organic wool, such as cotton or animal wool, which are considered to be pleasant for many, e.g. for interior designs. Animals kept for producing suitable wool are, e.g. sheep, camels, lamas, alpacas or yaks, i.e. sheep wool, camel wool, lama wool, alpaca wool or yak wool. Animal wool is hardly flammable. From a chemical perspective, animal wool can also be referred to as keratin fiber material. The sheared wool from the feet, throat, head or rear portion, particularly from body parts, for which the quality of the wool may not be sufficient for further use in the textile industry, can at least serve as an admixture for granulate in order to provide a beneficial factor of thermal conductivity or insulating factor. A special advantage of animal wool, such as sheep wool, consists in that it is antistatic. In other words, the wool prevents an electrostatic charging of the granulate.

It is also possible, to use plant parts in granulate, at least as an admixture. Fibrous plant parts, with which a wool-like structure can be formed, are preferably used. In chemical terms, a cellulose fiber material is counted among the usable plant fibers. Plant parts of grain straw, hemp, flax or flax plants are potential components for granulate. Even cork, e.g. recyclable bottle cork or recyclable cork boards, can at least be used as an admixture for the production of granulate.

Thanks to these different mixtures and combination options, granulate can be provided, which contain exclusively or—in an alternative design as an additional component, depending on the preference—one or more of the aforementioned materials, such as rock wool, glass wool, animal or natural wool or plant-fiber-like wools, particularly at least in part as a recycling material.

Granulate can be pretreated with a chemical prior to use as a raw insulation material, particularly prior to spraying. A pretreatment with an adhesive agent is beneficial. Granulate can be concatenated in a particle range, e.g. with a silicate binder. Water glass, such as potassium water glass, is particularly well suited. Potassium water glass can be referred to as a natural material, which is not registered by Dangerous Substances Directive RL 67/548/EEC. By adding the silicate binder, the granulate becomes softer and smoother. A façade surface can be smoothed more easily.

The adhesive is preferably applied in a droplet form. Adhesive dispersion or misting, for which an average droplet diameter of less than 3 mm is given, is suitable for a fine dispersion of the adhesive. An even better dispersion arises if the droplets in a mist of adhesive have a radius on average between 0.005 mm and 0.5 mm. The droplets are produced by spraying the adhesive. At least one nozzle that can also be referred to as an adhesive nozzle is provisioned, through which an adhesive, that is under a fluid pressure, is sprayed. By using a greater number, e.g. of four adhesive nozzles, which are preferably arranged at an equal distance from each other, a particularly uniform dispersion of adhesive droplets can be supplied over granulate. Particularly efficient is a dispersion of adhesive, upon which the adhesive enters the flow of surface covering material from all sides (in the context of an enveloping adhesive flow). This results in a particularly uniform coverage of the surface covering material through adhesive, thus improving the bond.

The granulate is supplied in a granulate volume flow to form the surface covering material. According to one definition, a volume flow of granulate or adhesive denotes a quantity of granulate or a quantity of adhesive that discharges respectively from the end of a granulate tube or from a nozzle in a predetermined unit of time, e.g. in one second. By setting a granulate volume flow, e.g. by means of a regulator on a device for the order, a spraying thickness of the surface covering material can be particularly accurately determined. The adhesive is supplied in an adhesive volume flow for binding the surface covering material. By specifying an adhesive volume flow, adhesive can be dispensed particularly sparingly. The granulate volume flow is preferably capable of being regulated. Regulating the adhesive volume flow can be provisioned. It is particularly beneficial if the granulate volume flow can be regulated independent of the adhesive volume flow. An independent, separate regulation is beneficial for creating a surface covering of a corner of the building part. The nozzle assembly is held in front of a surface to be covered. The granulate outlet opening is located at a distance from the surface, on which the surface covering material is to be applied. An overlap area is located at a distance smaller than this in front of the granulate outlet opening. In regular operation, for which the device is preferably intended, the overlap area is closer to the granulate outlet opening than the surface. The distance is preferably specified as a straight axial travel, starting from the granulate outlet opening. The axial travel extends along a central axis. The central axis can be determined through an extension of the nozzle assembly. The granulate outlet opening is considered for this purpose. The granulate outlet opening is transverse to the central axis. Approximately a center of the granulate outlet opening coincides with the central axis. The granulate volume flow and the adhesive volume flow overlap in the overlap area. The granulate outlet opening belongs to a spraying device, which has, e.g. a nozzle assembly. The adhesive and the granulate are separated in the spraying device. The granulate and the adhesive are respectively fed in a volume flow without mixing the two components fed supplied for spraying. Until they are discharged from the nozzle assembly, the adhesive and granulate are maintained and fed separately. The adhesive and granulate are conveyed without mixing.

The granulate is preferably used or discharged from the device in a non-moistened state. In other words, the granulate is not prepared with water. The granulate flows free of water. An ambient air humidity is negligible for this determination of a non-moistened state. The ambient air humidity is not taken into account for this consideration. The adhesive is applied for accumulation on the granulate. The adhesive can be an aqueous adhesive because water from the adhesive dries residue-free after spraying. Adhesive passes to the granulate in an air space. The air space is located in front of the surface to be covered. Thus, the adhesive is applied particularly uniformly on the granulate particles rotating in general about different axes. Adhesive also passes to surfaces of building parts, which (first or initially) are free of granulate. The adhesive forms a primer through the preliminary application, on which the granulate bonds particularly well. The granulate exits the spraying device with a flow speed generated by the air flow. The adhesive exits the spraying device with an adhesive flow speed. The flow speeds of the adhesive and granulate are preferably set to each other in such a way that the adhesive passes to an uncovered area faster than the granulate. Due to a beneficially selected flow speed of the granulate, sprayed granulate can bond better to the surface to be covered. In particular flow speeds can be set so that the flow speed of the granulate is less, e.g. approx. 5% to approx. 10%, than the flow speed of the adhesive. Discharging granulate and adhesive are combined in an air space, which is preferably located outside of the nozzle assembly. In one area of aggregation in front of the nozzle assembly, a volume element of the air space contains granulate particles and adhesive, particularly adhesive sprayed as a mist.

A spraying device is used to discharge granulate and adhesive. The granulate discharges preferably at least from a first opening. The adhesive discharges preferably from at least a single second opening. Depending on the design of the spraying device, it may be more beneficial if there are multiple second openings, from which respectively one part of the adhesive volume flow of the discharges. The first and second opening can be arranged on the same side of the spraying device, so that granulate and adhesive discharge in a parallel-like manner to each other, i.e. in an identical spatial direction. After discharging, an expansion occurs in an area, which is laterally respectively larger than the respective opening. The granulate moves through a granulate outlet tube and the adhesive moves through an adhesive tube of the spraying device.

The granulate can be largely isolated particles that often consist of a non-conductive material. In the case of non-conductive particles, separations of electrical charges can adapt to the surface, e.g. through friction of an electrically non-conductive wall. Electrostatic effects must be considered for separated electrical charges. In particular, homopolar charges can mutually repel each other. In other words, the granulate particles with a higher mass compared to adhesive droplets can carry electrostatic charges after being supplied through a spraying device. An electrical charge can be great enough that a bonding of the adhesive or the adhesive droplets to the granulate is hindered due to repulsion. To inhibit such an adverse effect and to enhance the bond, the spraying device is preferably supplied with an equal electric potential for the granulate outlet tube and the adhesive tube. It is also possible to provide an antipodal electric potential on an inner surface of the granulate outlet tube, which—during operation—comes into contact with granulate, and on an inner surface of the adhesive tube, which—during operation—comes into contact with adhesive. The inner surface faces a channel-like cavity in the inside of a tube. Through an antipodal potential, it is possible to facilitate an electrostatic attraction between adhesive droplets and granulate particles. In other words, an adhesive bond can be beneficially electrostatically influenced by the granulate, which move in an adhesive applied as a mist. In addition, electrostatic effects can be exploited in such a way that a potential difference between the granulate outlet tube and the surface to be covered is inhibited. A potential can be assigned with the help of an electrical supply line, which is connected to an electrical voltage source. It is also possible to ground the building part and the common spraying device respectively so that conformity with the electric potential is achieved. A worker, who holds the spraying device in his hands, is protected by the grounding of the spraying device from a discharge of electrical charges of a friction potential generated by the granulate from the spraying device across his body.

Prior to processing, the granulate should be stored in a dry place in order to be able to eliminate changing influences due to moisture changes on the granulate. The granulate has residual moisture, which depends on the ambient humidity of the air, particularly if a seal of a packaging unit of the granulate was broken. By storing in a heated container, the humidity of the raw insulating material, i.e. granulate, can be controlled. Due to the segregated storage of granulate and adhesive, there is no hazard of the granulate sticking together. However, humidity can cause granulate to clump. It has proved to be beneficial for processing if the granulate is set as bulk material. The bulk material can be set so that its ability to flow is maintained even with a relative atmospheric humidity of up to 98% (humidity is related to a maximum possible water vapor content of the air with a respectively present temperature and a respectively present air pressure). The granulate is exposed to an air flow. The air flow can be formed by compressed air that relaxes to an atmospheric air pressure. The reduction in pressure occurs directed through a tube or a hose. Particularly beneficial is a spiral hose, which has sufficient elasticity for moving particularly a nozzle assembly from a first location to a second location, preferably from a first height to a second height. The air flow is set so high that a force applied to the granulate by the air flow is greater than a weight force of the granulate. Such a configuration causes the air flow to suspend the granulate. The expanding air absorbs granulate and pushes it through the spiral hose. In the process, the source of compressed air, e.g. a fan, is situated on a reference plane. The granulate is conveyed by the air flow to a height that can be referred to as a spraying height. It is possible to achieve a desired spraying height of two meters (and even more than two meters) by the air from a fan.

A liquid glue, for example, is suitable as an adhesive. The liquid glue can have multiple parts. A first part of the liquid glue is an adhesive agent. A second part of the liquid glue can be water. The water can also serve to enhance a fluidity of the adhesive agent. Water glass, for example, is suitable as an adhesive agent. Adhesive agents can be produced with an admixture of styrene on the basis of methacrylic acid ester. It is possible to mix two or more adhesive agents. Adhesive agents are mixed, e.g. if a durability of the surface covering must be produced in varying climate conditions (e.g. cold and wet winters and in arid summer months). A mixed rock wool granulate/liquid glue mixture that is sprayed lands on the building to be insulated or its wall. The adhesive agent ensures an instant bond, particularly of the granulate.

The effect of the adhesive can be further improved if a binder is added. A binder can be used, e.g. in order to beneficially influence the hardening of the adhesive. A binder can also be used to promote the bonding of an adhesive. Milk is a suitable binder. Especially readily available is cow's milk, which can be added to the adhesive.

The effect of the adhesive can be further improved if a hydrophobing agent is added. Oil, preferably a vegetable oil, is suitable as a hydrophobing agent. Vegetable oils, for example, that do not pose a health hazard, can be used. A hydrophobing oil can dry by itself. Tests have proved linseed oil to be a preferred hydrophobing agent. It is also possible to use rapeseed oil or castor oil. The hydrophobing agent contributes to preventing a potential clogging of the nozzles.

One or more of the following agents can also be taken into consideration as adhesive additives: wallpaper glue, carboxymethyl cellulose, building plaster, clay powder or a raw carbon pulp. The listed materials can beneficially affect sliding and/or bonding properties during the production of a surface covering material.

Upon applying an insulating layer to a façade, it is desirable for the homeowner and the companies carrying out construction, particularly the workers, for reasons of work efficiency, etc. to make a color design of the surface together with the surface covering of building parts. Color pigments can be added to the adhesive without impacting adhesion. Emulsion paint can serve as one potential dye for the adhesive. A potential dye is admixture of pigment particles in the sub-micrometer range. A white pigment color can be made, e.g. by adding titanium dioxide particles to the adhesive. In addition, titanium oxide or titanium dioxide protects the granulate from UV radiation, which can be particularly unfavorable for a durability of some organic materials or polymers. Mineral pigments are particularly suitable, which do not negatively affect environmental or health compatibility.

For the work at a construction site, it has proven to be particularly time-saving if the adhesive is carried along already premixed. It is also possible to adapt the adhesive to the general conditions of the construction site, such as a surface consistency of a building part, desired thickness of the surface covering, desired color or desired surface structure, by means of an on-site mixing device. One example for a premixed adhesive is an adhesive that is mixed in multiple mixing steps. The mixing steps can be conducted sequentially. An adhesive can be kept, e.g. in a reservoir size of 30 liters, 50 liters or 100 liters. To prepare an adhesive agent mass, which can also be referred to as an adhesive compound, a binding agent, which can also be referred to in short as a binder, can first be mixed in water with a ratio of 2% w/w to 5% w/w with respect to 100% w/w of the adhesive agent. In a second step, a hydrophobing agent can first be premixed with water in a ratio between 2% w/w and 5% w/w with respect to 100% w/w of the adhesive agent. Binders and hydrophobing agents are preferably mixed with water respectively in equal parts. In a third step, the binder and the hydrophobing agent are additionally mixed together with water, such that an adhesive compound of 100% w/w emerges. However, the adhesive compound can also contain a part of up to approx. 80% w/w of a liquid glue, which is added in the third step. The liquid glue comprises a first adhesive agent, which is thus enhanced, particularly with regard to its adhesive properties, by mixing it with a second adhesive agent. In a fourth step, to the previously produced adhesive compound is added no more than the equal measure of water, such that the adhesive achieves a consistency suitable for spraying. It is possible to add a dye to the adhesive in one of the steps, e.g. in the fourth step.

The adhesive is preferably a liquid, which can be conveyed with a pressure by the pump. A pneumatically-powered pump works particularly reliably. The pneumatically-powered pump functions particularly bubble-free. In one embodiment, the pump can, e.g. continuously supply a pressure of at least 5 bar. The pump allows the adhesive to be conveyed at an equal height as the granulate. The pressurized adhesive is squeezed through an adhesive nozzle. Upon discharging from the nozzle, the adhesive atomizes. An adhesive mist forms. By appropriately choosing a nozzle arrangement and a nozzle shape, the atomized adhesive can pass to the granulate. The adhesive is misted in the direction of the moving granulate.

One embodiment of an adhesive is an adhesive compound consisting of an aqueous solution comprising liquid water glass based on potassium carbonate, wherein approx. 34 kg of a silicate binder that can be alkaline activated is also added to approx. 100 liters of water as an additional binder. In a second step, 1.5 kg of cow's milk as a binder, which is mixed with 1.5 kg of water, and 1.5 of a hydrophobing agent, which is mixed with 1.5 kg of water, are mixed. In a third step, 57 kg of the adhesive compound are mixed with the mixture consisting of binder and hydrophobing agent. In a fourth step, from the obtained 63 kg, 125 kg of a liquid that can be processed as an adhesive is generated by diluting it with water.

A device for applying a jointless surface covering functions particularly reliably and safely if there is an outlet opening between the combing device and the reservoir. The outlet opening serves to feed the granulate to the combing device. It is possible to provide a slide valve on the outlet opening, which adjusts an opening size of the outlet opening, e.g. to prevent the device from clogging. It is also possible to equip the outlet opening with a safety lock. The safety lock serves, e.g. to keep the outlet opening open only when a safety switch is actuated on the nozzle assembly, i.e. in an operational state. A hazard of unintentional operation in the combing device can therefore be prevented.

A conveyor shaft can be provisioned on the device, on which a number of blades are preferably situated. The conveyor shaft is preferably arranged in the reservoir at a distance from the outlet opening. The blades have an angular position in relation to the conveyor shaft, which can also be referred to as a blade shaft. By turning the blade shaft, granulate in the reservoir is moved to the outlet opening by the blades. The granulate falls through the opened outlet opening. The combing device is fed with granulate in a controlled manner by means of an adjustable speed of the blade shaft.

The combing device is preferably formed from two combing shafts. The twin-shaft configuration of the combing device extends preferably parallel to the blade shaft. The combing shafts and the blade shafts are particularly capable of being driven in at least one direction of rotation by a common, preferably electrically powered, drive unit, particularly via a switchable gearbox. The first and the second shaft of the combing device bear respectively a number of tines. The tines can protrude radially from the respective shaft. The tines are spread along a combing shaft axis. The tines on the first combing shaft are arranged with a gap in relation to the tines of the second combing shaft, such that the tines cannot jam against each other. In other words, the tines reach gaps when the combing shafts are turning. Tines on two shafts can be radially spaced from each other. A tine gap between a first tine on the first combing shaft and a second tine on the second combing shaft is at least as large as a granulate particle diameter. Both the first combing shaft and the second combing shaft are pivoted. The combing device preferably has no stator, so that granulate is not squashed or cut up.

In one beneficial embodiment, the combing device is arranged above a chute. The chute is located above the flow channel. In other words, a chute is provisioned between the combing device and the flow channel. A chute is a conveyor device, which functions with the gravity of the granulate. On the top, the chute has a smooth sliding surface for the granulate. Due to the smoothness, granulate does not adhere to the sliding surface. One embodiment of the chute has a first and a second wing. The wings can be configured so that granulate located on the first wing of the chute moves towards granulate located on the second wing of the chute. Gravity allows the granulate to fall from the chute.

A bottom side of the chute can also be referred to as the flow channel side of the chute. A shape may be present on the bottom side, which forms a part of the flow channel. The falling granulate passes into an air flow area that is present in the air flow channel. The air flows along an air flow guide plate, which can be a part of the chute, particularly a part of the first wing of the chute and/or a part of the second wing of the chute. The air flow guide plate directs an air flow towards an outlet opening from the flow channel. In particular, the air flow guide plate can form a constriction of the flow channel. An opening, which is arranged on the constriction of the flow channel, experiences a negative pressure due to the air flow that passes through the flow channel, such as in one configuration of a venturi tube. Due to the negative pressure, the assumption of granulate particles into the air flow, which traverses the flow channel, can be facilitated. In other words, an air flow guide plate serves to combine the air flow and a distribution of granulate.

The chute is aligned to the flow channel. An outlet gap is provisioned on the chute, which can also be referred to as a chute gap. An outlet gap length, which preferably corresponds to the length of the combing shaft, restricts an air discharge surface on the chute. The outlet gap has a gap width, which can also be referred to as the transverse direction of the outlet gap. The outlet gap enables the passage of a single granulate particle in the transverse direction. Two granulate particles arranged in a pair can pass through the gap because an alignment to the outlet gap is made by the chute. The outlet gap extends preferably along the combing device, such that there is preferably no pocket, in which granulate could settle. Granulate particles can only pass into the air flow individually with respect to the transverse direction of the outlet gap. In other words, granulate particles are introduced into the air flow, wherein a separation occurs. Granulate particles that adhere slightly to each other are separated on the outlet gap through the interaction of granulate fed by the combing device and the air flow through the flow channel.

A ground wire can be connected on the nozzle assembly. The ground wire produces an electrical contact. Granulate that flies through the nozzle assembly can at least in part rub on an inner surface of the nozzle assembly if the granulate fan hose is equipped with a smaller diameter for easier control. The granulate particle flow can cause a splitting of electrical charges into positive charges and negative charges. A respective excess charge present on the nozzle assembly can be discharged via the electrical ground wire. It is also possible for the charged granulate particles, which contact the nozzle assembly, to be discharged. This prevents unfavorable charge conditions, which could prevent a combination of granulate and adhesive on the underlying plane of the building part. An arrangement, for which the ground wire runs along the fan hose, is particularly beneficial. A discharge of surface charges of the granulate fan hose is thus simplified.

The cross-section of a hose becomes more stable through a coil consisting of metal, e.g. spring steel, or rigid plastic which is integrated into a hose lining throughout the entire length of the hose. The spiral of a so-called spiral hose can also preferably comprise a multi-wire electric wire, e.g. at least a voltage wire and a ground wire. It is possible to connect an electronic remote control on the nozzle assembly to a controller of the device via electrical wiring. The ground wire preferably forms an electrical connection from the nozzle assembly to an outlet opening of the flow channel.

It is particularly beneficial for operation if the nozzle assembly has a granulate outlet tube capable of being electrically impinged with a potential, which is shaped like an inner tube. The inner tube can be enclosed by a handle tube of the nozzle assembly, preferably connected to a ground wire, via electrical insulation.

A granulate flow can be regulated, e.g. by an air flow. Controlling the air flow is beneficial for the flow before the air flow enters the flow channel, such that a flow resistance is not increased for the granulate flow. After entering into the flow channel, a branch valve can be provisioned. The branch valve can be designed in such a way that it diverts a part of the air flow from the fan to the environment. Another option for controlling the air flow consists in provisioning a speed control on the fan. With the speed control, the fan can be set to the desired speed, e.g. to a slower speed in the range of less than 1,000 RPM if the air flow should be slowed. It is possible to control the granulate flow with the help of the combing device and particularly with the help of a speed of the blade shaft—at least as a rough adjustment. A fan speed and a shaft rotation are preferably aligned to each other, particularly through a controller. A speed of the combing device can be set by a motor drive of the combing device. A rotation of at least one of the provisioned shafts can also be controlled via temporal intervals. The combing device conveys granulate, which is absorbed by the air flow. Thus, it is possible, e.g. in a constant air flow, to achieve a variable granulate flow. This is particularly beneficial if the nozzle assembly is moved parallel to a surface to be covered by a surface positioning robot. Increasing the air flow is beneficial if a greater height or a greater distance compared to a starting position of the nozzle assembly must be overcome with the granulate.

In a preferred embodiment, the adhesive flow can be regulated. Particularly beneficial is a regulation, through which the granulate flow and adhesive flow can be adjusted. To regulate the adhesive flow, a manual control valve, which serves particularly as a shut-off valve, can be provisioned on the nozzle assembly. Controlling a drive of the adhesive pump provides another option for regulating the adhesive flow. If a compressed air driven adhesive pump is provisioned as a part of the device, the output of the pump can be adjusted with the drive pressure of the pump. A pump drive pressure regulator, for example, is suitable for this. The pump drive pressure regulator can work together with a compressor for compressed air. Regulated compressed air can be fed to the adhesive pump through a compressed air hose from the pump drive pressure regulator. The compressed air is preferably not present on the adhesive to prevent a reaction of the adhesive in the adhesive reservoir, e.g. due to contamination. The pump drive pressure regulator can also be connected to a compressed air cylinder. The compressed air cylinder serves as an energy source for the adhesive pump. The use of a compressed air cylinder is beneficial for an energy-efficient functioning of the adhesive pump. The compressor can charge the compressed air cylinder in an area of the greatest degree of effectiveness. The pump drive pressure regulator functions, preferably infinitely variably, together with an electronic control, particularly for a compressed air controller of a drive pressure supply of the adhesive pump from the compressed air cylinder.

A granulate flow and an adhesive flow must be frequently regulated during the production of a surface covering with respect to the situation on a building. Thus, a jointless surface covering can be produced in a controlled manner. A remote control, which is arranged on the nozzle assembly and with which, e.g. control commands can be given to the electric control, is particularly suitable for this. The controller can also be referred to as a control unit, which comprises electronic and/or electrical components, such as relays. The remote control is a part of the controller and can also be referred to as remote operation. The remote control can be actuated by a worker. The remote control can work together with sensors of a robot. Preferably a transportation of granulate as well as the fan and the at least one pump for adhesive can be variably regulated by the remote control, for example, to be able to particularly accurately apply a surface covering on building corners.

A controller serves in one embodiment for supplying the device with electrical energy. A coordinated interaction of the components of the device can be regulated via the controller. The device can be driven on rollers. A use of the device at various construction sites and buildings is possible in an energy self-sufficient manner particularly when using a self-sufficient energy supply, such as a generator. The device functions energy-efficiently. Ecologically compatible materials can be applied sparingly to buildings.

A fan regulator must be set on a desired air flow via a controller. The air flow is set so strong that a force applied to the granulate by the air flow is greater than a weight force of the granulate. This setting causes the granulate to be suspended by the air flow.

The method described is distinguished by several advantages. It can be easily modified within the scope of the present invention. A device for applying the raw insulating material likewise demonstrates advantages.

The surface covering can be troweled, particularly smoothened, directly after spraying. A building part, such as a façade which is to be preserved through the application of the method, e.g. with a renovation, is also distinguished by the fact that the built-up, especially renovated, façade is jointless. It depends completely on the preferences of those carrying out the project whether or not joints are to be introduced at some point into the façade. There are no air gaps, in which, e.g. birds can nest, unless cavities are shaped in the surface covering, such as through balloons or balls, for example, in order to provide living space for hole breeders. The ability to model the surface covering also provides possibilities for aesthetically appealing, in other words sculptural, i.e. artistic, designs on a building. The surface covering material can be homogenously applied, such that a first surface area does not differ from a second surface area of the surface coating. The surface covering can be manufactured without an additional final rendering and is highly durable after hardening, e.g. stable for more than 30 years. A surface covering durability can be further enhanced if the surface covering material contains a coarse-grain element and a fine-grain element, such as sand, wherein an average diameter of the fine-grain element constitutes preferably less than approx. 30% of an average diameter of the coarse-grain element. Among other things, a fine-grain element can serve to increase the density of a surface covering.

The surface covering is frost-resistant. Seasonal climate changes cannot damage the surface covering. Depending on the selection of the surface covering material, e.g. rock wool, the surface covering is breathable. An air circulation through the surface covering is possible, particularly through the building parts. Thus, for example, moisture can escape from living spaces so that a comfortable living environment is created. The air circulation reduces particularly a hazard of mold growth. Due to the utilized raw materials, no toxic or environmentally hazardous substances are emitted from the surface covering to the environment. Substances, such as phenol resins, which can pose a hazard in the event of a fire, are completely avoided. For example, only the potential formation dioxin, the harmful health effect of which is known, in the event of a fire is mentioned. It is possible to achieve a fire protection resistance, which is better than fire protection class F60. In tests, an exemplarily structured layer thickness of 12 cm demonstrated a resistance of more than 120 minutes, wherein the temperature was 1400° C., without risk of damage to a support structure below the surface covering, such as the masonry or wood. In other words, a melting point of a surface covering may be higher 1400° C.

A few achievable material properties are specified as examples:

A low density of approx. 100 kg/m3 (kilograms per cubic meter).

A low thermal conductivity of less than 0.1 W/mK (Watts per milliKelvin), e.g. with a lambda value of 0.0405 W/mK,

A low heat transition coefficient of less than 0.8 W/m²K (Watt per square meter and Kelvin) at 10 cm of layer thickness, e.g. with a k value (also called U value) of e.g. 0.41 W/m²K at 10 cm of insulation thickness,

Diffusion permeability for water vapor of up to 83%; in other words, a relative humidity of 83% in the layer thickness of the surface covering is not exceeded with an air exchange through the surface covering, and

A positive water vapor permeability with a low water vapor permeation resistance: for a final coat material comprising two parts of rock wool granulate and one part sand with a thickness of 1.5 mm, measurements from a test laboratory revealed a μ value of 8.0. For a floating material comprising granulated rock wool and an alkaline silicate binder with a thickness of 60 mm, measurements revealed a μ value of 3.0. A combination of both layers with an overall thickness of 7.5 mm revealed a μ value of 11.8 to 12.5, depending on whether or not the less dense floating layer or the comparatively somewhat denser final rendering was faced towards the moist atmosphere (in the present case, the physical structural definition is assumed that a greater μ figure indicates a denser construction material).

The device for applying the insulation material is preferably a modular system, on which individual components can be easily replaced. Particularly beneficial is a device that is dimensioned in such a way that it can be transported by a customary small transporter. At a construction site, the device can be operated by one person in order to perform the work necessary for applying the surface covering. The work efficiency can be further enhanced if the granulate reservoir is fed and the adhesive reservoir is fed or replaced through the support of a second person as needed. Adhesive and insulation raw material, particularly granulate, can be kept separate until immediately before processing.

The previously presented combinations and embodiments can be considered in several additional connections and combinations as well.

### BRIEF DESCRIPTION OF FIGURES

The present invention can be better comprehended if reference is made to the attached figures, which, for example, present particularly beneficial embodiments without limiting the present invention to them, wherein

FIG. 1 shows an embodiment of a device for applying jointless surface coverings to building parts,

FIG. 2 shows an embodiment of a device with a view of a nozzle assembly, and

FIG. 3 shows a configuration of nozzles on a nozzle assembly.

### DESCRIPTION OF FIGURES

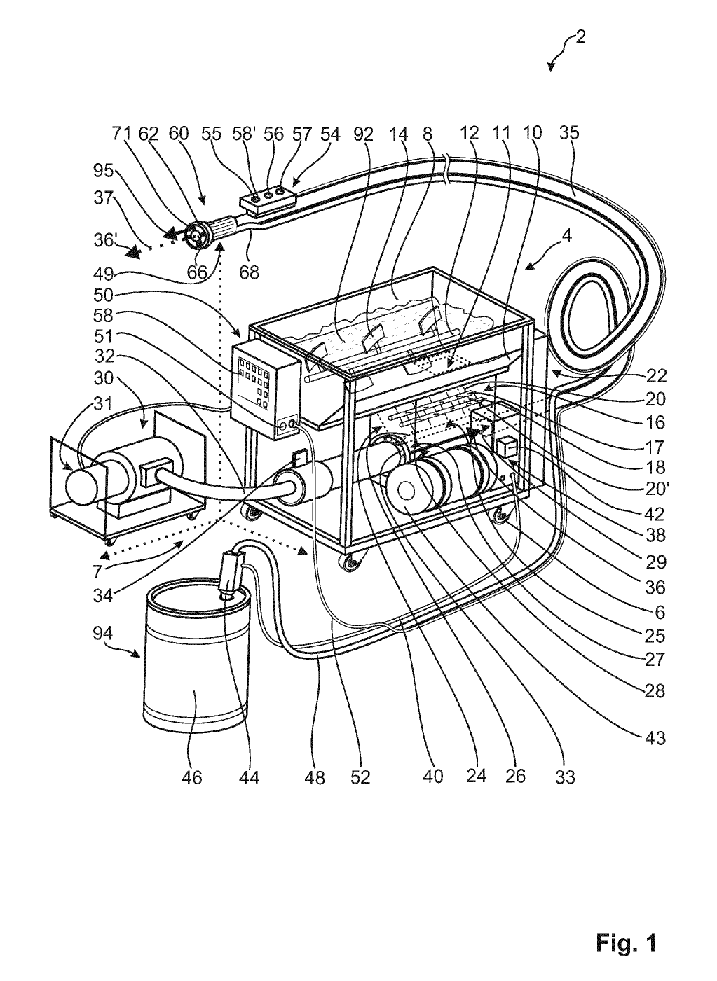

The embodiment of a device 2, depicted in FIG. 1, for applying a jointless surface covering, comprises a granulate cart 4, which stands with wheels, such as wheel 6, on a reference plane 7. Granulate 92 is located in granulate cart 4 inside a granulate reservoir 8, the bottom of which forms a trough 10. Trough 10 has an outlet opening 11 for granulate 92. A conveyor shaft 12 extends in the granulate reservoir 8, to which a number of blades, such as blade 14, attached. Blades 14 are intended for pushing granulate 92 to each other so that granulate 92 pass through outlet opening 11. Combing device 16 is arranged below outlet opening 11. Combing device 16 comprises a first combing shaft 17 and a second combing shaft 18, which can be collectively powered with a conveyor shaft 12 by drive unit 22 for a rotation. The rotation preferably occurs inversely and is particularly directed downwards between combing shafts 17, 18. Tines, such as tines 20, 20′, are attached to combing shafts 17, 18, which protrude like rods from combing shafts 17, 18. Combing device 16 is located between outlet opening 11 and a chute 24. Chute 24 has a chute gap 25. From one perspective, chute 24 is shaped like guide plate 26 for air flow, which facilitates an air flow 36 through flow channel 28. Flow channel 28 comprises an inlet flow opening 27 and an outlet flow opening 29. Valve 34 is connected to inlet flow opening 27 via a flange 33. Valve 34 is connected to a radial fan 30 via a fan hose 32. Radial fan 30 can be controlled via a fan controller 31, which is connected to an electric control 50. Control unit 58 serves to turn a power supply on and off via a socket 51. Additional control elements (without reference signs) are provisioned for individual control tasks. Control 50 is also electrically connected to a pump drive pressure regulator 42, which is located on compressor 38. Among others, compressor 38 serves to fill a pressure tank 43 with compressed air if pump drive pressure regulator 42 recognizes a pressure of pressure tank 43 that is less than a desired target pressure. Pressure tank 43 provides a supply pressure that is reduced to desired value via pump drive pressure regulator 42 for operating adhesive pump 44. Adhesive 94 from adhesive reservoir 46 can be fed into adhesive hose 48 as needed by adhesive pump 44. The compressed drive air is fed to adhesive pump 44 by pump drive pressure regulator 42 via compressed air hose 40.

An air flow 36 coming from radial fan 30 takes in granulate 92 and carries granulate 92 through outlet opening or escape opening 29 into a granulate fan hose 35. Granulate 92 passes with air flow 36 through granulate fan hose 35 to a spraying device 60, which, based on one aspect of handling, can also be referred to as a sprayer assembly 60. Together with a granulate flow 37, an air flow 36′ discharges from spraying device 60. Spraying device 60 comprises a spray head 62, into which a granulate outlet tube 66 and four nozzles, such as first nozzle 71, for adhesive 94 empty. An adhesive volume flow 95 discharges from the nozzle, which may thus also be referred to as an adhesive nozzle. Spraying device 60 can be brought to a desired spray height 49, which—depending on the building (not marked) can be located above a reference plane 7 (as depicted) or below reference plane 7 (not marked). Spraying device 60 also comprises an adhesive tube 68, which ends in the spray head 62 in order to supply the nozzles with adhesive, such as first nozzle 71. A remote control 54 is arranged on spraying device 60, which is connected to electric control 50 via a control line 52. Remote control 54 enables communication with electric control 50 through a signal transmission. A first switch 55 can be used to turn device 2 on or off. An operational state of device 2 is displayed on the respective control units, e.g. by an indicator light 58′ and an indicator light 58. A second regulator 56 can be used to adjust fan controller 31 to a desired air flow via control 50. A third regulator 57 can be used to adjust pump drive pressure regulator 42 for conveying adhesive 94 to a desired adhesive flow via control 50. Thus, granulate flow 37 and a flow of fed adhesive 94 can be accurately regulated by a worker (not depicted), who operates spraying device 60 in front of a surface of a building part to be coated.

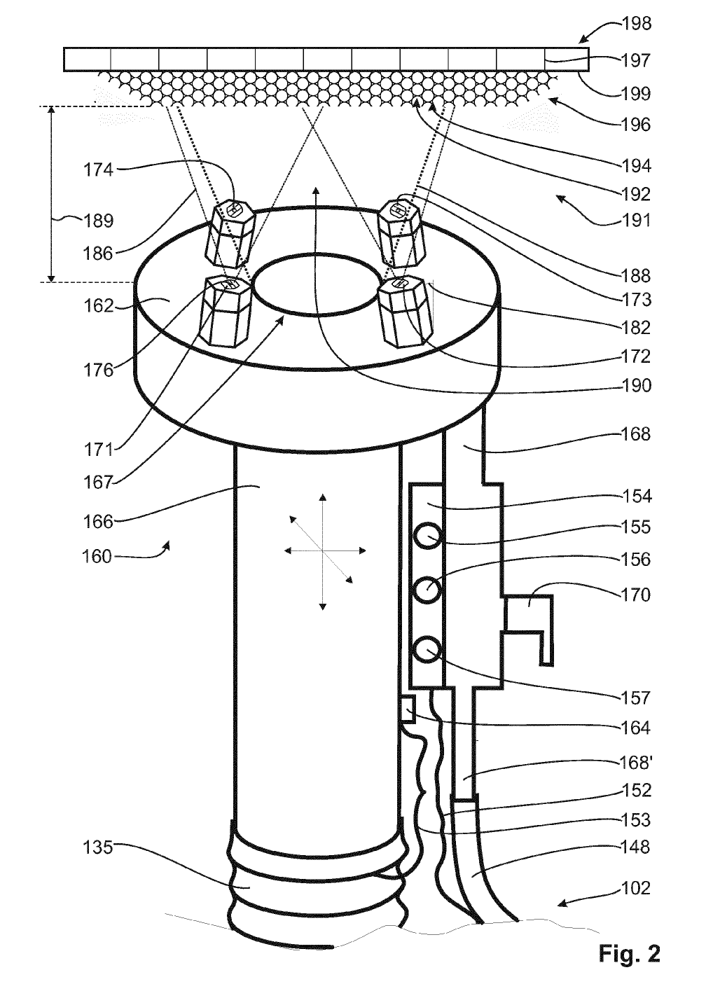

A spraying device 160 connected to a device 102 is shown in FIG. 2, which—as indicated by the delineated arrow of a spatial coordinate system—can be freely moved in space. In front of spraying device 160 there is a building part 198 or a part of a building, such as a wall, which has joints, such as a joint 197, which extend through building part 198 to a surface 199. Surface 199 forms the underlying plane for bonded granulate 192 and adhesive 194. Granulate 192 and adhesive 194 collectively form a surface covering material 196, which is schematically drawn very simplified as a section of a surface covering by surface covering material 196. It must be assumed that a density of granulate 192 in a surface covering material 196 most commonly is less than it is shown in FIG. 2 because granulate 192 are often present with a diameter dispersion. Moreover, small gaps in granulate 192 resulting from an immediate bonding of granulate 192 can often only be partially sealed in the way of a surface flow of granulate 192. Gaps are most commonly at least partially filled by adhesive 194.

A spray head 162, which is provisioned on spraying device 160, is located at a distance 189 in front of surface covering material 196. There is an air space 191 between surface covering material 196 and spray head 162. A first nozzle 171, a second nozzle 172, a third nozzle 173, and a fourth nozzle 174 protrude into air space 191, which are respectively facing a granulate tube end 167 with a nozzle angle, such as nozzle angle 182. Granulate tube end 167 of granulate outlet tube 166 is located on spray head 162, from where granulate outlet tube 166 extends to granulate fan hose 135, through which granulate 192 are fed to spraying device 160. Nozzles 171, 172, 173, 174 are supplied with adhesive 194 from an adhesive tube 168. A manually operable adhesive valve 170 is connected to adhesive tube 168. An adhesive tube 168′ goes from adhesive valve 170 to an adhesive hose 148, through which adhesive 194 is fed. A remote control 154, which has a first regulator 155, a second regulator 156, and a third regulator 157, is connected to adhesive tube 168, 168′. The functionality of regulators 155, 156, 157 can be programmed, such that it is possible to transmit various control signals via a control line 152 to device 102. A ground wire 153 as a connecting wire goes from spiral hose 135, which comprises a metal coil, to a ground connection 164, which is located on granulate outlet tube 166. Nozzles 171, 172, 173, 174 respectively have a nozzle opening, such as nozzle opening 176 on first nozzle 171. Adhesive 194 is emitted with a pressure from nozzle opening 176, such that the adhesive is spread like a mist in an area, which is schematically delineated as an adhesive spray cone 186. There is an overlap area 190 in air space 191, in which an adhesive spray cone of nozzles 171, 172, 173, 174, such as adhesive spray cone 186, spatially overlaps with a spray cone 188 of granulate 192. Spray cone 188 of granulate 192 indicates an angle range, in which granulate 192—carried by air—can pass, i.e. without moving spraying device 160, to surface 199 or to surface covering material 196, which was already applied.

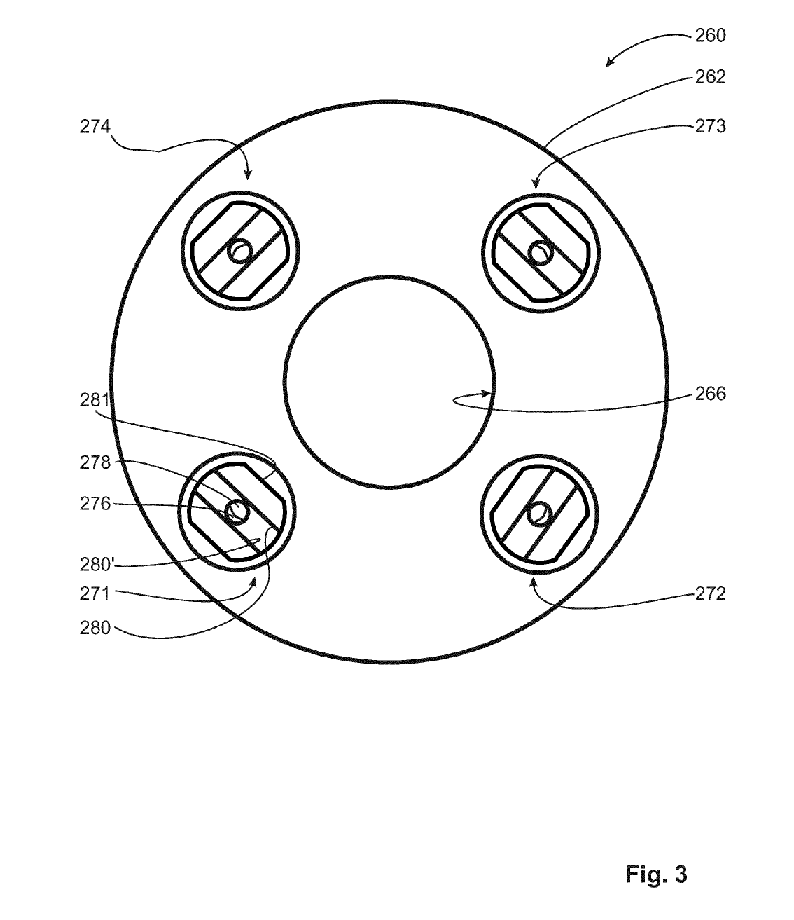

A top view of a spray head 262 of a spraying device 260 is shown in FIG. 3. On spray head 262, a first nozzle 271, a second nozzle 272, a third nozzle 273, and a fourth nozzle 274 are arranged, which are designed similarly. Nozzles 271, 272, 273, 274 are arranged together on the corners of an imaginary square, wherein granulate outlet tube 266 concludes in the center of the square. Granulate outlet tube 266 is electrically insulated with respect to spray head 260, such that granulate outlet tube 266 can be impinged with an electric potential with respect to spray head 260. As delineated exemplary on first nozzle 271, nozzles 271, 272, 273, 274 have a nozzle opening 276 and at least one key edge, such as key edge 281, which facilitates unscrewing a defective nozzle. Nozzle opening 276 is embedded between a first atomized spray screen 280 and a second atomized spray screen 280′. Atomized spray screens 280, 280′ confine a spreading of adhesive (not delineated). This prevents, e.g. that with an absence of an air flow from granulate outlet tube 266, granulate outlet tube 266 from gradually becoming sticky due to the adhesive. On nozzle opening 276, there is an atomized spray guide ridge 278, which serves to generate a dispersion of an adhesive mist (not delineated) differing from a cone shape out of nozzle opening 276. As a result, it is possible to spray the adhesive particularly evenly onto granulate (not delineated) leaving the granulate outlet tube 266.

The embodiments depicted in the individual figures can be connected to each other in any configuration.

### LIST OF REFERENCE SIGNS

2, 102 Application device, particularly a spraying device
4 Granulate cart, particularly as a rack cart
6 Wheel, particularly a lockable wheel
7 Reference plane
8 Granulate reservoir
10 Trough
11 Outlet opening
12 Conveyor shaft
14 Blade
16 Combing device
17 First combing shaft
18 Second combing shaft
20, 20′ Tines
22 Drive unit, particularly a motor drive
24 Chute
25 Chute gap, particularly as an outlet gap
26 Guide plate, particularly for air flow
27 Inlet opening
28 Flow channel
29 Outflow opening
30 Fan, particularly a radial fan
31 Fan controller
32 Fan hose
33 Flange
34 Valve, particularly a branch valve
35, 135 Granulate fan hose, particularly a spiral hose
36, 36′ Air flow or air stream
37 Granulate flow
38 Compressor
40 Compressed air hose
42 Pump drive pressure regulator
43 Pressure tank
44 Adhesive pump
46 Adhesive reservoir
48, 148 Adhesive hose
49 Spraying height
50 Electric control
51 Socket, particularly power supply
52, 152 Control line
153 Ground wire
54, 154 Remote control
55, 155 First regulator, particularly a switch
56, 156 Second regulator
57, 157 Third regulator
58, 58′ Control element, particularly in the form of indicator lights or with indicator lights
60, 160, 260 Spraying device, particularly a nozzle assembly
62, 162, 262 Spray head
164 Electrical connection, particularly ground
66, 166, 266 Granulate outlet tube
167 Granulate tube end, particularly a granulate outlet opening
68, 168, 168′ Adhesive tube
170 Adhesive valve
71, 171, 271 First nozzle, particularly an adhesive nozzle
172, 272 Second nozzle, particularly an adhesive nozzle
173, 273 Third nozzle, particularly an adhesive nozzle
174, 274 Fourth nozzle, particularly an adhesive nozzle
176, 276 Nozzle opening
278 Atomized spray guide ridge
280, 280′ Atomized spray screen
281 Key edge
182 Nozzle angle
186 Adhesive spray cone
188 Spray cone, particularly of the granulate
189 Distance, particularly straight axial travel
190 Overlapping area
191 Air space
92, 192 Granulate, particularly in form of granulate particles
94, 194 Adhesive
95 Adhesive volume flow
196 Surface covering material, particularly surface coating
197 Joint
198 Building part
199 Surface, particularly an underlying plane

What is claimed is:

1. A method for applying a jointless surface covering to building parts, such as on walls or ceilings, by means of spraying from a distance of a flow of a surface covering material and an adhesive, so that surface covering material impinging on the building part bonds to and hardens on an underlying plane, created by the building part or by a coating, particularly one that was previously applied, e.g. of a insulation material,
characterized in that
as raw insulation material granulate of the surface covering material becomes airborne and, misted with the adhesive, impacts a surface to be covered and by influence of the adhesive instantly reacts in a concatenating manner so as to bond to the surface, and, in particular, begins to harden, thereby forming the insulation material.

2. Method according to claim 1, characterized in that the granulate consisting of flakes is produced through a shredding process, e.g. with the help of a hammer mill or e.g. with the help of a kieserite machine, wherein the granulate constitutes a source material for the flow of the surface covering material.

3. Method according to claim 1, characterized in that
the granulate is present in an average particle size of 6 mm to 8 mm.

4. Method according to claim 1, characterized in that
the granulate is mechanically pretreated with a combing device, in particular for separating clumped granulate particles.

5. Method according to claim 1, characterized in that
the granulate comprises wool, such as mineral wool, glass wool, cotton, sheep, lama or alpaca wool, particularly from shears of the feet, throat or head, and/or plant parts, such as straw, hemp, flax, linen or cork, at least as an admixture.

6. Method according to claim 1, characterized in that
the granulate is wetted with an adhesive agent, such as water glass, before spraying.

7. Method according to claim 1, characterized in that
the adhesive is provisioned as droplets with an average diameter of less than 3 mm, preferably with an average radius between 0.005 mm and 0.5 mm, wherein the adhesive, is sprayed through at least one, preferably four, adhesive nozzles.

8. Method according to claim 1, characterized in that
a granulate flow rate of the surface covering material and an adhesive flow rate, which are preferably separately adjustable, are overlapped at a minimum distance of a granulate outlet opening, which is smaller than a straight axial travel from the granulate outlet opening to the area to be covered, wherein the adhesive and the granulate are provisioned and conveyed separately through a spraying device.

9. Method according to claim 1, characterized in that
an accumulation of the adhesive on the, particularly non-moistened, granulate in an air space in front of the area to be covered and on an uncovered area occurs, wherein preferably a flow velocity of the granulate is less than an adhesive flow velocity.

10. Method according to claim 1, characterized in that
the granulate and the adhesive are emitted through a common spraying device having a granulate outlet tube and an adhesive tube, wherein the spraying device provides an identical electrical potential or an antipodal electrical potential on an inner surface of the granulate outlet tube and an inner surface of the adhesive tube, through which an adhesive coating of the granulate is electrostatically affected when misted, wherein particularly the granulate outlet tube is allocated to an identical electrical potential as the surface to be covered due to electrical grounding.

11. Method according to claim 1, characterized in that
the granulate in a dry state, which corresponds in particular to an ambient air humidity of less than 98%, levitates by means of flowing compressed air and, conveyed preferably through a spiral hose, is applied at a height of at least two meters above a reference plane.

12. Method according to claim 1, characterized in that
the adhesive is a liquid adhesive, which contains water and at least one adhesive agent, such as potassium water glass and/or a methacrylic ester with a styrene admixture.

13. Method according to claim 1, characterized in that
a binder, such as milk, particularly cow's milk, is added to the adhesive.

14. Method according to claim 1, characterized in that a hydrophobing agent, such as oil, preferably vegetable oil, particularly linseed oil, is added to the adhesive.

15. Method according to claim 1, characterized in that a dye is added to the adhesive.

16. Method according to claim 14, characterized in that
the adhesive is premixed in mixing steps, wherein binder with a part between 2% w/w and 5% w/w, hydrophobing agent with a part between 2% w/w and 5% w/w, and, particularly for diluting, water with a part of 40% w/w to 50% w/w is added to an adhesive compound, preferably sequentially, respectively related to a mass of 100% w/w, and in particular the liquid adhesive is squeezed through a pneumatically-powered pump with a pressure of at least 5 bar for atomizing, particularly bubble-free and continuously through an adhesive nozzle.

17. A device for applying a jointless surface covering to building parts,
wherein the device has a granulate reservoir,
a fan connected to the granulate reservoir for conveying the granulate through a granulate fan hose,
an adhesive pump connected to an adhesive hose, wherein the adhesive pump is designed to convey adhesive from an adhesive reservoir,
and a nozzle assembly, which is connected to the granulate fan hose and the adhesive hose,
characterized in that
the granulate from the granulate reservoir can be fed to a chute through a combing device for separating granulate particles, and
the chute is designed for transferring granulate particles into an air flow provided by the fan in a flow channel, with which the application of the granulate particles and the adhesive, combined in an air space, is enabled for surface covering.

18. Device according to claim 17, characterized in that a, particularly adjustable, outlet opening is provided between the combing device and the reservoir and the combing device can be fed with granulate through the outlet opening, preferably by means of a number of blades mounted on a blade shaft, wherein particularly the combing device is a twin-shaft configuration with tines protruding respectively radially and reaching into each other's gap.

19. Device according to claim 17, characterized in that
the chute, particularly on the flow channel side, is designed as a, preferably dipterous, air flow guide plate, which facilitates in particular a transfer of granulate particles in accordance with the operating principle of a venturi tube.

20. Device according to claim 17, characterized in that
the chute has an outlet gap for granulate particles, which enables the granulate particles to be in a singularized manner introduced into the air flow in a transverse direction to an air flow.

21. Device according to claim 17, characterized in that
an electrical ground wire is present on a nozzle assembly, through which load separations caused particularly by a granulate particle flow, which counteract the application, are compensated, wherein the ground wire preferably extends along the granulate fan hose from an outflow opening of the flow channel to the nozzle assembly.

22. Device according to claim 17, characterized in that
a granulate flow is adjustable by the air flow, particularly via a branch valve upstream of the flow channel and particularly via a motor drive of the combing device, and an adhesive flow is adjustable particularly via a pump drive pressurized air regulator allocated to the adhesive pump, preferably continuously, particularly separately.

23. Device according to claim 17, characterized in that the air flow is adjustable via a control and a fan regulator and/or the air flow is set so strongly that a force by the air flow applied on a granulate or on the granulate flow is greater than a weight force of the granulate, particularly in the granulate flow.
